(19) United States
(12) Patent Application Publication
(10) Pub. No.: US 2016/0104395 A1
(43) Pub. Date: Apr. 14, 2016

(54) REMOVABLE LABLELING CLIP ASSEMBLY FOR ATTACHMENT TO FOOD CONTAINERS

(71) Applicant: Cassandra Klein, Minot, ND (US)

(72) Inventor: Cassandra Klein, Minot, ND (US)

(21) Appl. No.: 14/512,331

(22) Filed: Oct. 10, 2014

(51) Int. Cl. G09F 3/02; G09F 3/16

(52) U.S. Cl. CPC G09F 3/02; G09F 3/16; G09F 2003/0272

(57) ABSTRACT

A removable labeling clip assembly for connecting to food containers and identifying the contents thereof The removable labeling clip assembly comprises a flexible connector disposed between an attachment device and a labeling structure. In the preferred embodiment, the attachment device is defined as a spring loaded clip, the flexible connector is embodied as an elongated, flexible neck that can be repositioned through the application of manual pressure, and the labeling structure defines a permanently attached whiteboard card. In alternate embodiments, the attachment device may define a magnet, and the labeling structure may be embodied as a disposable labeling card. In operation, the labeling structure is employed to document the contents of a food container and it is held above or around the container by the flexible connector and the attachment device.

### BACKGROUND OF THE INVENTION

1. Field of the Invention

This invention relates generally to removable labeling apparatus and, more particularly, to a labeling clip which can be removably attached to a food container, such as a bowl.

2. Description of the Prior Art

The use of stickers and markers to label or otherwise identify bowls and other food containers is well known. A problem which still exists, however, is once marked with stickers and markers, it is often difficult to remove the marking or sticker so enable the container to be used for other dishes or foods. Thus, there remains a need for a removable labeling clip assembly for attachment to food containers so that they can be temporarily labeled to identify their contents. It would be helpful if such a removable labeling clip assembly employed an attachment device that facilitated direct, removable attachment to the food container. It would be additionally desirable for such a removable labeling clip assembly included a flexible neck that allowed the labeling structure to be set in a desired orientation relative to the attachment device.

The Applicant's invention described herein provides for a removable labeling clip assembly adapted to attach to a food container to enable the contents thereof to be identified. The primary components in Applicant's removable labeling clip assembly are an attachment device, a flexible neck, and a labeling structure. When in operation, the removable labeling clip assembly enables the labeling of food containers so their contents can be known without defacing the container. As a result, many of the limitations imposed by prior art structures are removed.

### SUMMARY OF THE INVENTION

A removable labeling clip assembly for connecting to food containers and identifying the contents thereof. The removable labeling clip assembly comprises a flexible connector disposed between an attachment device and a labeling structure. In the preferred embodiment, the attachment device is defined as a spring loaded clip, the flexible connector is embodied as an elongated, flexible neck that can be repositioned through the application of manual pressure, and the labeling structure defines a permanently attached whiteboard card. In alternate embodiments, the attachment device may define a magnet, and the labeling structure may be embodied as a disposable labeling card. In operation, the labeling structure is employed to document the contents of a food container and it is held above or around the container by the flexible connector and the attachment device.

It is an object of this invention to provide an extension bar for a removable labeling clip assembly for attachment to food containers so that they can be temporarily labeled to identify their contents.

It is another object of this invention to provide a removable labeling clip assembly that employed an attachment device that facilitated direct, removable attachment to the food container.

It is yet another object of this invention to provide a removable labeling clip assembly that included a flexible neck that allowed the labeling structure to be set in a desired orientation relative to the attachment device.

These and other objects will be apparent to one of skill in the art.

### BRIEF DESCRIPTION OF THE DRAWINGS

FIG. 1 is a side perspective view of a removable labeling clip assembly attached to a food container in accordance with the preferred embodiment of the present invention.

FIG. 2 is a side elevational view of a removable labeling clip assembly attached to a food container accordance with an alternate embodiment of the present invention.

### DETAILED DESCRIPTION OF THE INVENTION

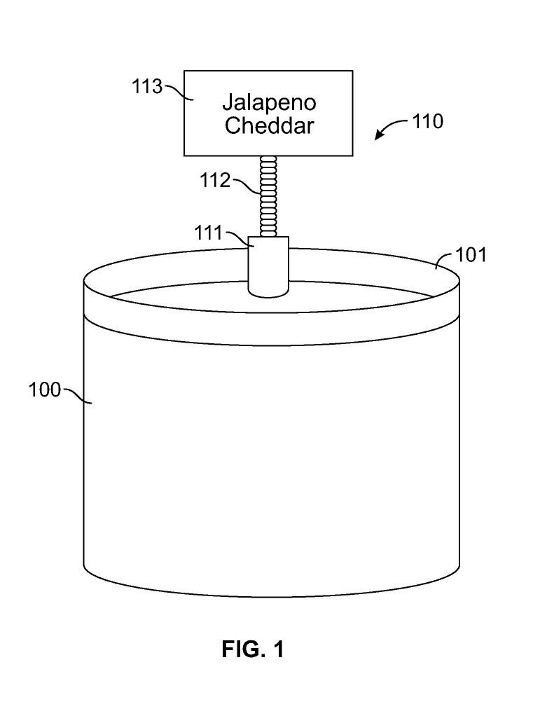

Referring now to the drawings and in particular FIG. 1, the preferred embodiment of a removable labeling clip assembly 110 is shown as an attachment device, a flexible connector, and a labeling structure. In the preferred embodiment, the attachment device is defined as a spring loaded clip 111 that can be removably connected to the rim 101 of a conventional food container, such as a bowl 100.

The end of the spring loaded clip 111 opposite the side that attaches to the rim 101 of a bowl 100 is connected to one end of a flexible connector, defined as a flexible neck 112. The flexible neck 112 defines an elongated, flexible structure that can be repositioned through the application of manual pressure but remains in its current position in the absence of such manual pressure. In this regard, the flexible neck 112 is operative be positioned and freely repositioned in a similar fashion to conventional twist ties.

Connected to the end of the flexible neck 112 opposite the attachment device is the labeling structure. In the preferred embodiment, the labeling structure defines a permanently attached labeling card 113 having a glossy, white surface for nonpermanent markings.

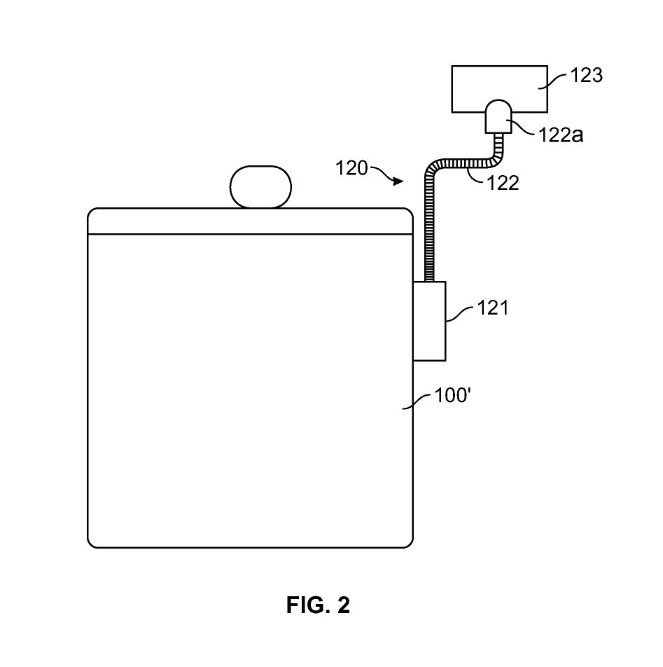

Referring now to FIG. 2, an alternate embodiment of a removable labeling clip assembly 120 also includes an attachment device, a flexible connector, and a labeling structure. In an alternate embodiment, the attachment device alternatively defines a magnet 121 that can be removably attached to the outside or inside surface of a metallic bowl 100′. The flexible connector is defined as an elongated, flexible neck structure 122 that is connected to the attachment device and operated as in substantially the same manner as the flexible neck of the preferred embodiment. In an alternate embodiment, the end of the flexible neck 122 opposite the attachment device is a spring loaded clip 122a.

The spring loaded clip 122a on the flexible neck 122 enables the removable attachment of a disposable labeling structure, defined in an alternate embodiment as a labeling card 123. Identifying information can be printed on the labeling card 123, and its disposable nature enables the use of a new card anytime the contents of the bowl 100′ changes. Advantageously, the use of the spring loaded clip 122a to attach disposable labeling card 123 allows the removable labeling clip assembly 120 to operate with conventional, disposable flash cards or other conventional paper products.

The instant invention has been shown and described herein in what is considered to be the most practical and preferred embodiment. It is recognized, however, that departures may be made therefrom within the scope of the invention and that obvious modifications will occur to a person skilled in the art.

1. A removable labeling clip assembly for attaching to a food container, comprising:
attachment device for removably connecting to a conventional food container, wherein the attachment device defines at least one of a spring loaded clip or a magnet;
a flexible connector having a proximal end and a distal end, wherein the proximal end is attached to said attachment device and said flexible connector is operable to be selectively repositioned through the application of manual pressure but remain in a current position in the absence of such manual pressure; and
a labeling structure attached to the distal end of the flexible connector, wherein the labeling structure is adapted display written indicia relating to the contents of the food container to which the attachment device is connected.

2. The removable labeling clip assembly for attaching to a food container of claim 1, wherein the attachment device is defined as a spring loaded clip.

3. The removable labeling clip assembly for attaching to a food container of claim 1, wherein the attachment device is defined as a magnet.

4. The removable labeling clip assembly for attaching to a food container of claim 1, wherein the proximal end of the flexible connector is permanently attached to said attachment device.

5. The removable labeling clip assembly for attaching to a food container of claim 1, wherein labeling structure is permanently attached to the distal end of the flexible connector.

6. The removable labeling clip assembly for attaching to a food container of claim 5, wherein the labeling structure is defined as a blank surface for nonpermanent markings.

7. The removable labeling clip assembly for attaching to a food container of claim 1, wherein the labeling structure is removably attached to the distal end of the flexible connector.

8. The removable labeling clip assembly for attaching to a food container of claim 7, wherein the distal end of the flexible connector defines a spring loaded clip.

9. The removable labeling clip assembly for attaching to a food container of claim 7, wherein the labeling structure is defined as a disposable labeling card.
